(19) United States
(12) Patent Application Publication
(10) Pub. No.: US 2014/0150815 A1
(43) Pub. Date: Jun. 5, 2014

(54) DISC-BRUSH HOLDER APPARATUS, DISC-BRUSH ASSEMBLY, AND SUBSTRATE PROCESSING METHODS

(71) Applicant: APPLIED MATERIALS, INC., Santa Clara, CA (US)

(72) Inventor: Hui Chen, Burlingame, CA (US)

(73) Assignee: Applied Materials, Inc., Santa Clara, CA (US)

(21) Appl. No.: 13/691,542

(22) Filed: Nov. 30, 2012

(51) Int. Cl. A46B 13/00; B08B 1/00

(52) U.S. Cl. CPC A46B 13/008; B08B 1/001
USPC 134/6; 15/21.1

(57) ABSTRACT

In one aspect, a disc-brush pad holder apparatus is disclosed. The disc-brush pad holder apparatus has a first portion adapted to couple to a rotatable adapter, and a pad holding portion having a frontal surface receiving a disc-brush pad, the pad holding portion having a flexible radially-extending disc portion that flexes during cleaning. Disc-brush assemblies and methods of processing substrates are provided, as are numerous other aspects.

### FIELD

The present invention relates generally to semiconductor device manufacturing, and more particularly to a disc-brush holder apparatus adapted to clean a substrate surface.

### BACKGROUND

Within semiconductor substrate manufacturing, a planarization process may be used to remove various layers, such as oxides, copper, or the like. Planarization may be accomplished by pressing an abrasive disc-brush polishing pad containing a polishing solution against the substrate. Following this planarization process, a cleaning process may be utilized to remove polishing solution and/or particles from the substrate.

A disc-brush apparatus may be used to clean surfaces of the substrate. A typical disc-brush holder apparatus includes a disc-brush pad of a porous or sponge material, such as polyvinyl acetate, mounted on and adhered to a very stiff mandrel. For example, the disc-brush holder may be employed in a substrate processing system, such as in a substrate chemical and mechanical cleaning system (CMP system), to clean and/or scrub a major surface of a substrate during substrate processing.

As a result of use of the disc-brush pad in the CMP system, the surface of the disc-brush pad may become worn, and/or may accumulate agglomerated material. Typically, such disc-brushes may be replaced, but replacement is expensive, time consuming, and may take the scrubber brush equipment off line for extended periods of time. Accordingly, improved disc-brush apparatus, assemblies, and methods are sought.

### SUMMARY

In a first aspect, a disc-brush holder apparatus is provided. The disc-brush holder apparatus includes a first portion adapted to couple to a rotatable adapter, and a pad holding portion coupled to the first portion and having a frontal surface adapted to receive a disc-brush pad, the pad holding portion having a radially-extending disc portion having a spring rate of less than about 30 lb/in when measured by applying a force of 3 lb at an radially-outermost periphery of the radially-extending disc portion.

In another aspect of the invention, a disc-brush assembly is provided. The disc-brush assembly includes a disc-brush holder adapted to receive a disc brush pad, the disc-brush holder including a first portion, and a pad holding portion coupled to the first portion and having a frontal surface adapted to receive a disc-brush pad, the pad holding portion having a radially-extending disc portion having a spring rate of less than about 30 lb/in when measured by applying a force of 3 lb at an radially-outermost periphery of the radially-extending disc portion; an adapter adapted to couple to the first portion of the disc-brush holder and rotate the disc-brush holder; and a substrate holder adapted to position a substrate adjacent to the disc-brush holder.

In yet another aspect, a method of processing a substrate is provided. The method includes providing a substrate in a substrate holder; providing a disc-brush holder including a pad holding portion receiving a disc-brush pad, the pad holding portion having a radially-extending disc portion; and flexing the radially-extending disc portion while rotating the disc-brush holder in contact with the substrate.

Other features and aspects of the present invention will become more fully apparent from the following detailed description of example embodiments, the appended claims, and the accompanying drawings.

### BRIEF DESCRIPTION OF THE DRAWINGS

FIG. 1A illustrates an isometric view of a disc-brush holder according to embodiments.

FIG. 1B illustrates a rear plan view of a disc-brush holder according to embodiments.

FIG. 1C illustrates a cross-sectioned side view of a disc-brush holder of FIG. 1B taken along section lines 1C-1C.

FIG. 1D illustrates an enlarged partial end plan view of a slot of a disc-brush holder of FIG. 1B.

FIG. 1E illustrates a partial, cross-sectioned view of a disc-brush holder with the disc-brush pad removed for clarity according to embodiments.

FIG. 1F illustrates a partial, cross-sectioned view of a disc-brush holder with the disc-brush pad attached and shown in an un-flexed condition according to embodiments.

FIG. 1G illustrates a partial, cross-sectioned view of a disc-brush holder with the flexible radially-extending disc portion shown in a flexed condition according to embodiments.

FIG. 2 illustrates a partially cross-sectioned side view of a disc-brush assembly cleaning a substrate according to embodiments.

FIG. 3 illustrates a cross-sectioned side view of a disc-brush assembly shown biased to an unloaded configuration according to embodiments

FIG. 4 illustrates an isometric view of a portion of a disc-brush assembly according to embodiments.

FIG. 5 illustrates a flowchart of a method of processing a substrate according to embodiments.

### DETAILED DESCRIPTION

Embodiments described herein relate to apparatus, assemblies, and methods adapted to clean a surface of a substrate using a disc-brush pad in semiconductor device manufacturing. In one or more embodiments, a disc-brush holder apparatus is provided that includes a first portion (e.g., a shaft) adapted to couple to a rotatable adapter that is driven by a suitable motor, and a pad holding portion coupled to the first portion and having a frontal surface that is adapted to receive a disc-brush pad. The pad holding portion has a radially-extending disc portion having relatively low spring rate, such as a spring rate of less than about 30 lb/in when measured by applying a force of 3 lb at a radially-outermost periphery of the radially-extending disc portion. The radially-extending disc portion may be made up of two or more flexible wings in some embodiments. The flexible wings may be formed by radially extending slots. Other features of the radially-extending disc portion are described herein.

The disc-brush holder apparatus may be used in a disc-brush assembly that is adapted to clean a substrate. The disc-brush assembly may be employed in a substrate processing system, such as a substrate cleaning system, to scrub and/or clean a major surface of a substrate during substrate processing. Disc-brush assembly includes the disc-brush holder as described above that is adapted to receive the disc-brush pad, and that exhibits a relatively low spring rate thus providing flexibility. Disc-brush assembly includes a rotatable adapter coupled to the first portion of the disc-brush holder which is adapted rotate the disc-brush holder, and a substrate holder adapted to position a substrate adjacent to the disc-brush holder and disc-brush pad. Substrate holder may be rotated and translated as the substrate is pressed against the disc-brush pad to clean the substrate. In one or more embodiments, the radially-extending disc portion includes a non-planar surface in an un-flexed condition when not in contact with the substrate. The radially-extending disc portion flexes when in contact with the substrate. This flexibility allows for misalignment between the disc-brush pad holder and the substrate holder. In another aspect, the disc-brush holder may be rapidly removed and replaced as will be apparent from the following.

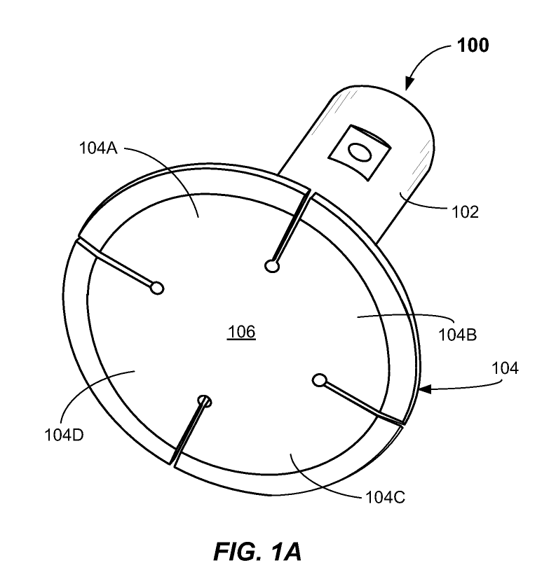

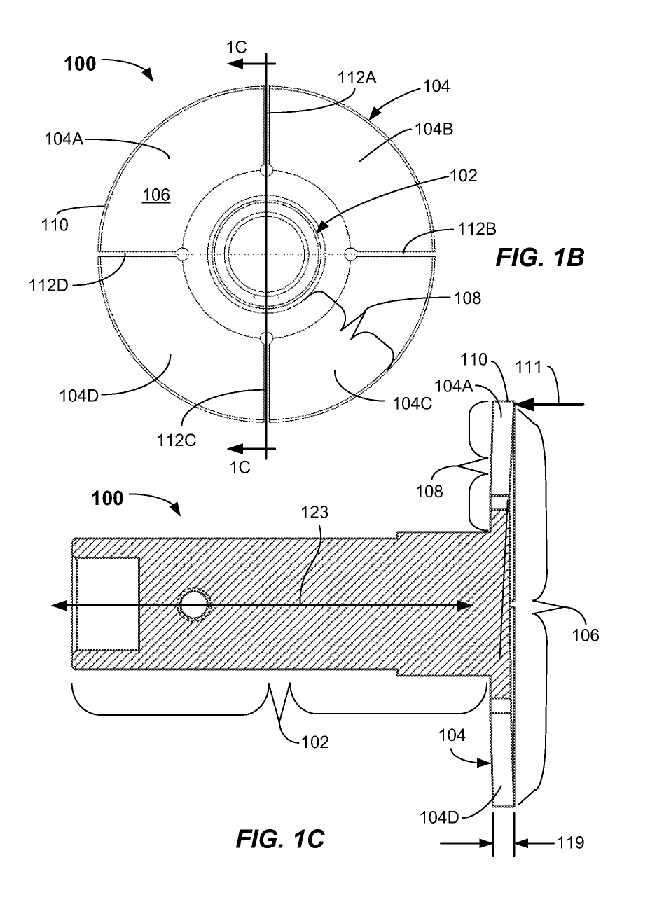

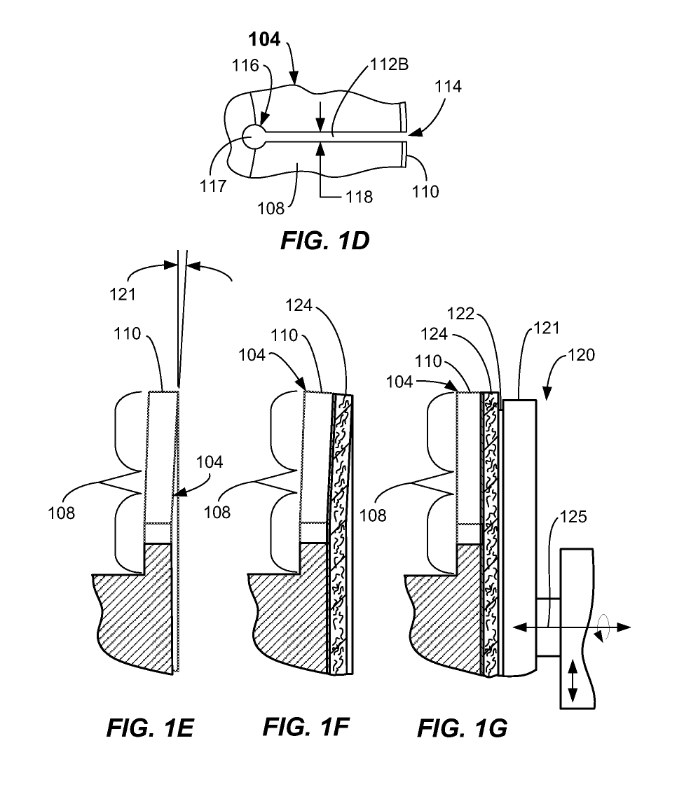

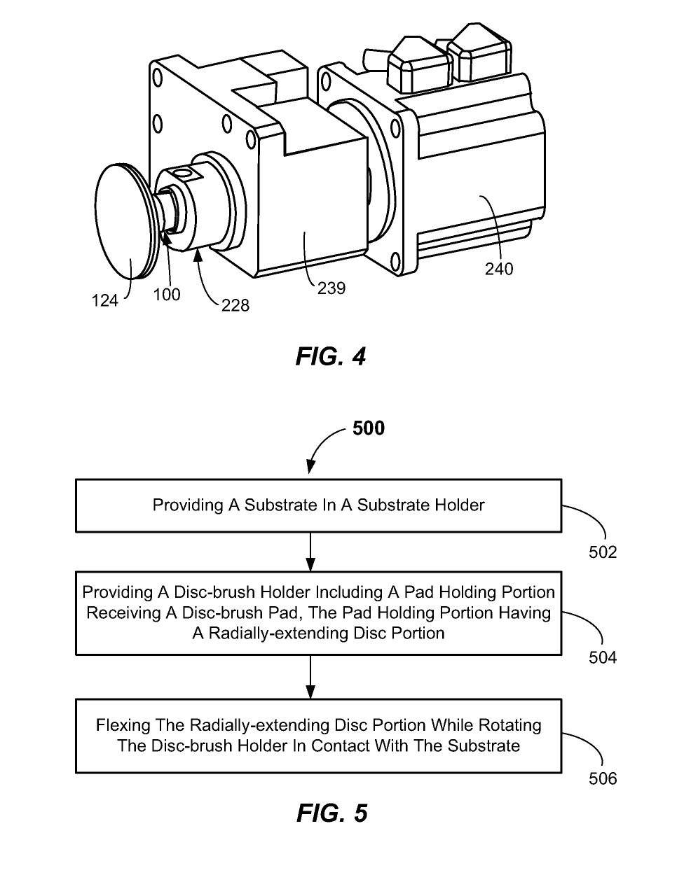

These and other aspects of embodiments of the invention are described below with reference to FIGS. 1A-5 herein.

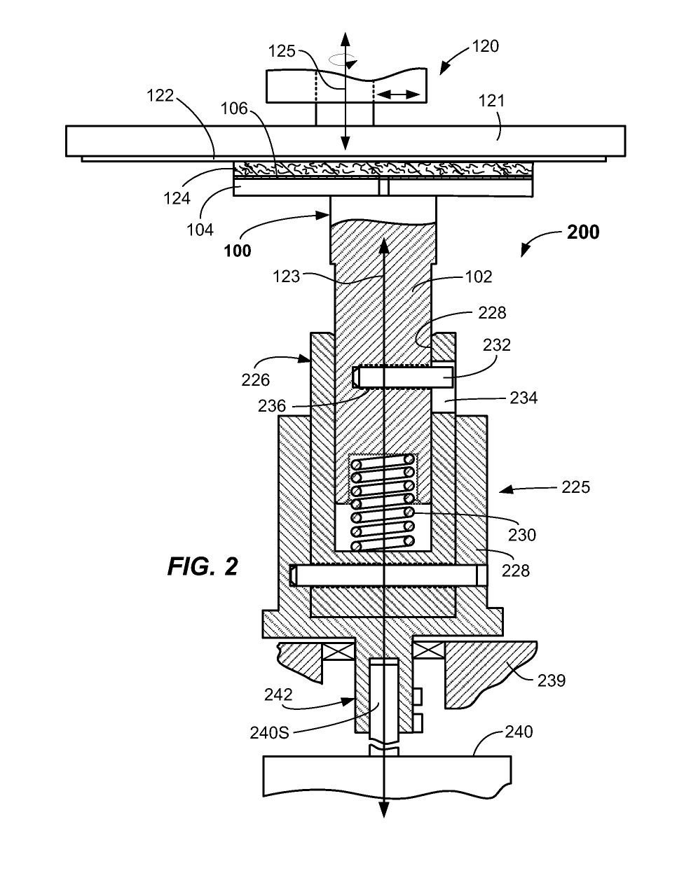

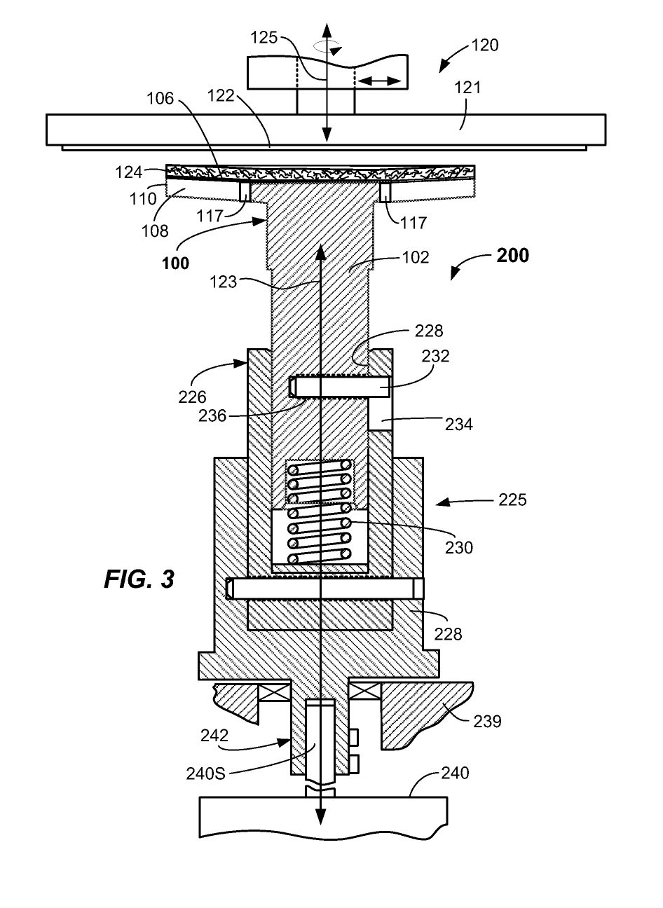

FIGS. 1A-1G illustrate various views of a disc-brush holder 100 and components thereof. The disc-brush holder 100 is adapted to hold a disc-brush pad 124 (FIG. 1F-1G) and may be received in a disc-brush assembly 200 (FIGS. 2 and 3) and is useful for cleaning a substrate as will be apparent from the following description. The disc-brush holder 100 has a first portion 102 adapted to couple to a rotatable adapter 226 of a rotator assembly 225 (FIG. 2), and a pad holding portion 104 coupled to the first portion 102 and having a frontal surface 106 adapted to receive the disc-brush pad 124 (FIGS. 2 and 3). Disc-brush pad 124 may be a circular element having a thickness of about 2 mm, for example. Disc-brush pad 124 may be made of a POLITEX™ polishing pad material available from DOW, for example. The pad holding portion 104 has a radially-extending disc portion 108 having a relatively low spring rate imparting flexibility thereto. The spring rate may be less than about 30 lb/in when measured by applying a force of 3.0 lb at a radially-outermost periphery 110 of the radially-extending disc portion 108 as designated by arrow 111 in FIG. 1C. The spring rate may be between about 20 lb/in and 30 lb/in when measured by applying a force of 3 lb at the radially-outermost periphery 110. In the depicted embodiment, the first portion 102 comprises a shaft, and the radially-extending disc portion 108 extends outwardly from the shaft. However, any suitable means for coupling to a rotator assembly 225 may be used, such as a bolted connection or the like.

As shown, the disc-brush holder apparatus 100 includes two or more flexible wings 104A-104D. Four flexible wings 104A-104D are shown, but any suitable number of flexible wings may be used, such as two, three, four, five or more. Flexible wings 104A may be formed by a plurality of slots 112A-112D that may extend inwardly from the radially-outermost periphery 110 of the radially-extending disc portion 108. Again slots may number two, three, four, five or more. The plurality of slots 112A-112D may extend inwardly from the radially-outermost periphery 110 toward an axial center of the pad holding portion 104, thus forming the plurality of flexible wings 104A-104D. The flexible wings 104A-104D may be unsupported along at least a portion of a radial extent thereof. For example, the flexible wings 104A-104D may be unsupported on a back side thereof from the outermost radial periphery 110 to a location of the intersection with the first portion 102.

As best shown in FIG. 1D, a portion of the pad holding portion 104 is shown having a representative slot 112B of the plurality of slots 112A-112D. Each slot 104A-104D may comprise a first open end 114 adjacent to the radially-outermost periphery 110 and a second closed end 116 radially inward from the first open end 114. Each of the plurality of slots 112A-112D may include an enlarged portion 117 having a cross dimension (e.g., across the frontal surface 106) at the second closed end 116 that is larger than a width 118 of the slot (e.g., 112B). This enlarged portion 117 functions to reduce stresses at the closed ends of the slots 112A-112D. The enlarged portion 117 should be located very near to the first portion 102 where it is coupled to the pad holding portion 104.

The radially-extending disc portion 108 may have an axial thickness 119 (FIG. 1C) of between about 1.9 mm and 2.1 mm, for example. The thickness 119 may be relatively constant along a radial extent of the radially-extending disc portion 108, or may be slightly thicker near the location of the first portion 102. Radially-extending disc portion 108 may be manufactured from a suitably flexible material, such as a plastic material. Other thicknesses may be used. The plastic material may be a polyetheretherketone (PEEK) material, for example. In one or more embodiments, the pad holding portion 104 and the first portion 102 are formed as one piece. For example, the disc-brush holder 100 may be entirely formed of a PEEK material, and may be formed by injection molding, machined from a block of plastic material, or formed by combinations thereof.

According to another aspect, the frontal surface 106 of the radially-extending disc portion 108 may comprise a non-planar surface. In particular, the frontal surface 106 located at the radially outermost periphery 110 may be spaced axially forward from a centermost portion of the frontal surface 106, such that the frontal surface 106 may be formed as a concave surface in an unstressed or undeflected condition (See FIG. 1E showing a half portion). In particular, as is shown in FIGS. 1E and 3, in one or more embodiments the radially-extending disc portion 108 may comprise a frustocone shape on the frontal surface 106. In some embodiments, non-planar surface 106 may include a draft angle 121 of greater than about 0.1 degrees formed thereon. The draft angle 121 may be between about 0.1 and about 2.0 degrees in some embodiments. In other embodiments, the draft angle 121 may be greater that about 0.5 degrees. In yet other embodiments, the draft angle 121 may be between about 1.5 and about 2.0 degrees. In some embodiments, a central portion of the frontal surface 106 may be planar and the outer radial portion may be a frustocone. The frustocone may extend from the outermost radial periphery 110 to at least the enlarged portion 117.

FIGS. 1F and 1G illustrates how the flexible radially-extending disc portion 108 flexes from a concave surface in an unstressed or undeflected condition to a flattened condition in operation as the substrate holder 120 holding the substrate 122 moves radially outwards towards the radially outermost periphery 110. In this manner, any non-parallelism between the central axis 123 (FIG. 1C) of the disc-brush pad holder 100, as installed, and the center axis 125 of the substrate holder 120, as installed, is accommodated. In particular, as the substrate 122 held and moved in substrate holder 120 is undergoing a cleaning process, the two or more flexible wings 104A-104D are flexed and elastically deformed by the axial pressure being applied by the substrate 122 on the disc-brush pad 124.

FIG. 2 illustrates disc-brush assembly 200 according to another embodiment of the invention. Disc-brush assembly 200 includes the disc-brush holder 100 as previously described, which is adapted to receive the disc-brush pad 124 on the frontal surface 106 thereof. Disc brush pad 124 may be received on the frontal surface 106 of the disc-brush holder 100 by adhering to the frontal surface 106 via a suitable adhesive, such as a silicone-based adhesive. Disc-brush assembly 200 further includes an adapter 226 adapted to couple to the first portion 104 of the disc-brush holder 100 and operable to rotate the disc-brush holder 100 and thus the disc-brush pad 124 about the central axis 123. Disc-brush assembly 200 includes the substrate holder 120, which is adapted to position the substrate 122 adjacent to the disc-brush holder 100 and the attached disc-brush pad 124. The substrate holder 120 is adapted to both rotate and translate the substrate 122 via rotating and translating the holder head 121 while the substrate 122 is pressed axially against the disc-brush pad 124.

The adapter 226, as depicted, may include a bore 228 (e.g., a cylindrical bore) that is adapted to receive the first portion 104 of the disc-pad holder 100, which may be configured as a cylindrical shaft. The first portion 104 may be configured to be axially moveable relative to the adapter 226 in some embodiments. In particular, as shown, the first portion 102 may be axially slidable within the bore 228. However, relative rotation between the first portion 102 and the adapter 226 may be restrained. The rotational restraint may be accomplished by a restrainer 232 riding against a restraining surface 234 of the adapter 226. In the depicted embodiment, the restrainer 232 may be a set screw or other like removable fastener that may be removable from a hole 236 in the first portion 104. For example, the restraining surface 234 may be formed as a side part of a slot wherein the restrainer 232 may slide axially in the slot. A spring 230 may be axially compressed as a result of pressure being applied on the disc-brush pad 124 by the substrate 122. Thus, when the substrate 122 is not in contact with the disc brush pad 124, the first portion 102 and thus the disc-brush holder 100 is biased via the spring 230 to an axially outer position at the end of the slot as shown in FIG. 3, and upon application of pressure, the restrainer 232 moves away from the end of the slot to an axially inner position as is shown in FIG. 2. Thus, the first portion 104 is axially spring biased relative to the adapter 226. In operation, a degree of motion of the first portion 102 in the bore 238 is dictated by the spring rate of the spring 230, which may have a spring rate of less than 32 lb/in, and between about 25 lb/in and 30 lb/in in some embodiments.

As shown in FIGS. 2-4, the adapter 226 may be coupled to a chuck 228 and the chuck 228 may be coupled to a drive motor 240 via a suitable coupling 242. Chuck 228 may be constrained by and rotatable within bearings mounted relative to a housing 239. Coupling 242 may clamp on to a shaft 240S of the drive motor 240. Motor 240 may be driven at a frequency of between about 100 rpm and 700 rpm during cleaning. Motor 240 may have an output torque of between about 0.25 Nm and 0.4 Nm. Other speeds and torques may be used.

FIG. 5 illustrates a method 500 of processing a substrate (e.g., substrate 122), and in particular a method of cleaning a substrate after undergoing a planarization or other polishing process. The method 500 includes, in 502, providing a substrate (e.g., substrate 122) in a substrate holder (e.g., in a holder head 121 of a substrate holder 120), and, in 504, providing a disc-brush holder (e.g., disc-brush holder 100) holding a disc-brush pad (e.g., disc-brush pad 124), the disc-brush holder including a pad holding portion (e.g., pad holding portion 104) receiving the disc-brush pad, the pad holding portion having a radially-extending disc portion (e.g., radially-extending disc portion 108 having suitable flexibility as described herein). The method 500 includes, in 506, flexing the radially-extending disc portion while rotating the disc-brush holder in contact with the substrate. In this manner, the flexible radially-extending disc portion (e.g., radially-extending disc portion 108) flexes elastically as shown in FIG. 2 as the cleaning process takes place. Additionally, the method 500 may include moving (e.g., sliding) the disc-brush pad holder (e.g., disc-pad holder 100) axially relative to an adapter (e.g., adapter 226) upon applying an axial contact force onto the disc-brush pad with the substrate in the substrate holder. This feature allows for a precise axial force to be applied. In one or more embodiments, the flexing includes elastically deforming the radially-extending disc portion (e.g., radially-extending disc portion 108) such that a portion that is flexed so that a frontal surface is substantially even axially with a center portion of the radially-extending disc portion as shown in FIG. 2. Substantially even means less that a draft angle 121 of less than about 0.1 degrees remains.

As should be apparent, the disc-brush pad holder 100 may be easily removed from the adapter 226 when the disc-brush pad 124 is in need of replacement (e.g., due to wear) by simply retracting the retainer 232 (e.g., set screw) from the hole 236 and removing the disc-brush pad holder 100 by sliding the first portion 102 out of the bore 228. A new disc-brush pad holder 100 having a new disc-brush pad 124 may be installed and by reversing this process.

Accordingly, while the present invention has been disclosed in connection with example embodiments thereof, it should be understood that other embodiments may fall within the scope of the invention, as defined by the following claims.

The invention claimed is:

1. A disc-brush holder apparatus, comprising:
a first portion adapted to couple to a rotatable adapter, and
a pad holding portion coupled to the first portion and having a frontal surface adapted to receive a disc-brush pad, the pad holding portion having a radially-extending disc portion having a spring rate of less than about 30 lb/in when measured by applying a force of 3 lb at an radially-outermost periphery of the radially-extending disc portion.

2. The disc-brush holder apparatus of claim 1, comprising: two or more flexible wings.

3. The disc-brush holder apparatus of claim 1, comprising:
a plurality of slots extending from the radially-outermost periphery of the radially-extending disc portion.

4. The disc-brush holder apparatus of claim 1, wherein first portion comprises a shaft and the radially-extending disc portion extends outwardly from the shaft.

5. The disc-brush holder apparatus of claim 1, comprising a plurality of slots extending from the radially-outermost periphery toward a center of the pad holding portion forming a plurality of flexible wings.

6. The disc-brush scrubber apparatus of claim 5, wherein the plurality of slots comprise a first open end adjacent to the radially-outermost periphery and a second closed end radially inward from the first open end.

7. The disc-brush holder apparatus of claim 6, wherein each of the plurality of slots comprises an enlarged portion having a dimension larger at the second closed end that is larger than a width of the slot.

8. The disc-brush scrubber apparatus of claim 1, wherein the radially-extending disc portion comprises two or more flexible wings that are unsupported along a portion of a radial extent thereof.

9. The disc-brush scrubber apparatus of claim 1, wherein the radially-extending disc portion has an axial thickness of between about 1.9 mm and 2.1 mm.

10. The disc-brush scrubber apparatus of claim 1, wherein the frontal surface of the radially-extending disc portion comprises a non-planar surface.

11. The disc-brush scrubber apparatus of claim 10, wherein the non-planar surface comprises a draft angle of between about 1.5 and about 2.0 degrees.

12. A disc-brush assembly, comprising:
a disc-brush holder adapted to receive a disc brush pad, the disc-brush holder including
a first portion, and
a pad holding portion coupled to the first portion and having a frontal surface adapted to receive a disc-brush pad, the pad holding portion having a radially-extending disc portion having a spring rate of less than about 30 lb/in when measured by applying a force of 3 lb at an radially-outermost periphery of the radially-extending disc portion;
an adapter adapted to couple to the first portion of the disc-brush holder and rotate the disc-brush holder; and
a substrate holder adapted to position a substrate adjacent to the disc-brush holder.

13. The disc-brush scrubber assembly of claim 12, wherein the radially-extending disc portion comprises two or more flexible wings that are unsupported along a portion of a radial extent thereof.

14. The disc-brush scrubber assembly of claim 12, wherein radially-extending disc portion has an axial thickness of between about 1.9 mm and about 2.1 mm.

15. The disc-brush scrubber assembly of claim 12, wherein the frontal surface of the radially-extending disc portion adapted to receive a disc-brush pad comprises a non-planar surface.

16. The disc-brush scrubber assembly of claim 12, comprising axially spring biasing the first portion relative to the adapter.

17. The disc-brush scrubber assembly of claim 12, comprising a restrainer axially slidable relative to the adapter.

18. A method of processing a substrate, comprising:
providing a substrate in a substrate holder;
providing a disc-brush holder including a pad holding portion receiving a disc-brush pad, the pad holding portion having a radially-extending disc portion; and
flexing the radially-extending disc portion while rotating the disc-brush holder in contact with the substrate.

19. The method of claim 18, comprising moving the disc-brush pad holder axially relative to an adapter by applying an axial contact force onto the disc-brush pad with the substrate in the substrate holder.

20. The method of claim 18, wherein the flexing comprising elastically deforming the radially-extending disc portion such that a portion flexed is substantially even axially with a center portion of the radially-extending disc portion.
